(19) United States
(12) Patent Application Publication
(10) Pub. No.: US 2010/0069600 A1
(43) Pub. Date: Mar. 18, 2010

(54) ELECTROCHEMICAL 18F EXTRACTION, CONCENTRATION AND REFORMULATION METHOD FOR RAIOLABELING

(75) Inventors: Jean-Luc Morelle, Liege (BE); Samuel Voccia, Liege (BE); Gauthier Philippart, Grand-Rechain (BE)

Correspondence Address: MERCHANT & GOULD PC, P.O. BOX 2903, MINNEAPOLIS, MN, 55402-0903, US

(73) Assignee: Trasis S.A., Liege (BE)

(21) Appl. No.: 12/439,943

(22) PCT Filed: Sep. 5, 2007
(86) PCT No.: PCT/BE07/00102

§ 371 Date: Oct. 28, 2009

Related U.S. Application Data
(60) Provisional application No. 60/842,435, filed on Sep. 6, 2006.

(30) Foreign Application Priority Data
Dec. 11, 2006 (EP) 06447128.7

(51) Int. Cl. C08G 63/78; B01D 59/40; G21G 4/00

(52) U.S. Cl. 528/271; 205/770; 204/274

(57) ABSTRACT

A method to extract out of water, concentrate and reformulate [18F] fluorides includes passing a dilute aqueous [18F] fluoride solution entering by an inlet (1) in a cavity (6) embodying an electrochemical cell with at least two electrodes (3, 4, 5), flowing in the cavity (6) and coming out of the cavity (6) by an outlet (2), an external voltage being applied to the electrodes. One electrode (4) is used as an extraction electrode, another one (3) is used for polarizing the solution, and configured so that at least the extraction electrode (4), either used as a cathode or as an anode, is in contact with and polarizes a large specific surface area conducting material (7), contained in the cavity (6). The extracted ions are released from the surface of the large specific surface area conducting material (7) by turning off the applied external voltage. During its passage in the cavity (6), the dilute aqueous [18F] fluoride solution entirely crosses and internally soaks the large specific surface area conducting material (7).

### TECHNICAL FIELD

The present invention relates to an electrochemical method of extraction, concentration and reformulation of [18F] fluorides contained in water. [18F] fluorides are generally produced by irradiation of H₂¹⁸O (i.e. enriched water) with protons. In further steps the [18F] radioactive ions can be transferred to an organic medium suitable for a nucleophilic substitution, which is generally the first step of a radiotracer synthesis.

### BACKGROUND ART

Positron emission tomography (PET) is an imaging method to obtain quantitative molecular and biochemical information about in vivo human physiological processes. The most common PET radiotracer in use today is [18F]-fluorodeoxyglucose ([18F]-FDG), a radiolabeled glucose molecule. PET imaging with [18F]-FDG allows to visualize glucose metabolism and has a broad range of clinical indications. Among positron emitters, that include [11C] (half-life of 20 min.), [15O] (2 min.), [13N] (10 min.) and [18F] (110 min.), [18F] is the most widely used today in the clinical environment.

As mentioned, [18F] fluorides are produced by irradiation of water (containing H₂¹⁸O) with protons resulting in the reaction ¹⁸O(p,n)¹⁸F. Only a minor fraction of the is converted. The enriched [18O] water used as target material is expensive and is therefore usually recovered. For production efficiency, it is desirable to use water that is as highly enriched as possible. The physics of production of [18F] fluorides by proton bombardment of water (amount of heat produced, proton energy range) typically requires at least 1 ml of water. The volumes coming out of most cyclotron targets are in practice made of several ml.

The [18F] isotope is then separated from water and processed for production of a radiopharmaceutical agent. Conventional fluoride recovery is based on ion exchange resins. The recovery is carried out in two steps: first the anions (not only fluorides) are separated from the enriched water and trapped on the resin (these resins have to be carefully processed before use, for instance to prevent chlorine ions contamination) and then, the anions, including [18F] fluorides, are released into water mixed with solvents containing potassium carbonate and a phase transfer catalyst such as Kryptofix 222® (K222). The [18F] fluorides radiochemical recovery yield is very effective, usually exceeding 99%. The most usual labeling method, nucleophilic substitution, requires anhydrous or low water content solutions. Thus, a drying step is still necessary after recovery. It usually consists in multiple azeotropic evaporation of ACN. This drying step takes several minutes.

On the other hand, new PET-imaging radiopharmaceutical research, based on peptides and protein originating from the proteomic, are about to emerge, addressing major health concerns such as cancer treatment follow-up or Alzheimer disease, rheumatism diseases diagnostic and follow-up, etc. From a scientific point of view, new chemical pathways are required for providing intrinsically higher purity compounds (or precursors), this purity being higher by 2 or 3 orders of magnitude to those achieved routinely in PET production today. This qualitative step is required by the nature of the new peptides and protein imaging agents of tomorrow's molecular imaging. Applied to such agents, the current methods would not make possible any meaningful metabolic image.

The recovery of [18F] fluoride from [18O] water using the electric field deposition (EFD) method has already been reported in the literature [Alexoff et al: Appl. Radiat. Isot., 1989, 40, 1; Hamacher et al: J. Labelled Compd. Radiopharm., 1995, 37, 739; Saito et al: Appl. Radiat. Isot., 2001, 55, 755; Hamacher et al: Appl. Rad. Isot., 2002, 56, 519, Hamacher et al: WO-A-02/090298; Hyodo et al: US-A-2003/0010619]. However, this process that allows deposition yields of 60 to 95% of the [18F] activity, depending on the field intensity and the material used, does not allow the release of more than 70% of the activity deposited on the electrode after excitation of the cell with an electric field even when an opposite polarity is applied. These studies have also evidenced the important affinity of the fluoride ions for carbon surfaces as compared with other conducting surfaces such as platinum. However, the high voltage level, amounting from dozens to hundreds of volts, required to reach a fair extracting electric field was reported to cause some side reactions such as electrode crumbling (release of particles) and water electrolysis.

The following prior art illustrates the EFD technology.

U.S. Pat. No. 5,770,030 discloses a separation method of ionizable or polarizable, carrier-free radionuclides by electrofixation, from a low electric conductivity liquid target material in a flow cell fitted with a permanent electrode arrangement (electrodeposition at high field on an anodic surface of vitreous carbon). The target liquid is separated while the fixing voltage (up to 30V for a maximum electric field of 300V/cm) is maintained; then the fixed radionuclide is removed again from the electrode, if required by heating, after switching off or reversing the poles of the field, after an optional intermediate rinsing. The fixing electrode surface area is of about 3 cm².

Patent application N° EP 1 260 264 A1 discloses a method of separating and recovering ¹⁸F from ¹⁸O water at high purity and efficiency while maintaining the purity of ¹⁸O water. By using a solid electrode as an anode and a container (electrodeposition vessel) made of platinum as a cathode, ¹⁸F in a solution is electrodeposited on the solid electrode surface by applying a voltage. Then, by using said solid electrode on which ¹⁸F is electrodeposited as a cathode and a container (recovery vessel) holding pure water therein as an anode, ¹⁸F is recovered in the pure water by applying a voltage of opposite polarity to that of the electrodeposition. Solid electrode materials presenting enlarged surface area are preferred, such as graphite or porous platinum.

A new opportunity to recover and concentrate [18F] fluorides was found in the electrical double layer extraction (EDLE) process. This electrochemical process is already used in seawater desalination [Yang et al: Desalination, 2005, 174, 125; Wilgemoed et al: Desalination, 2005; 183, 327], as well in battery regeneration (U.S. Pat. No. 6,346,187 B1), where it is known as capacitive deionization. Indeed, at the interface between an electrically charged surface (electrode) and an electrolyte solution there is a built-up of ions to compensate for the surface charge, the well-known electrical double layer. The term “electrical double layer” was first put forward in the 1850′s by Helmholtz, and there are a number of theoretical descriptions of the structure of this layer, including the Helmholtz model, the Gouy-Chapman model and the Gouy-Chapman-Stern model. The attracted ions are assumed to approach the electrode surface and to form a layer balancing the electrode charge; the distance of approach is assumed to be limited to the radius of the ion and the sphere of solvation around each ion. It results in a displacement of the ions from the solution toward the electrode and when the electrode specific surface area is large, the amount of “extractable” ions can be high enough to quantitatively extract the ions present in a solution.

The two electrochemical processes described above are fundamentally different. Several basic differences are listed hereinafter:

| Electric Field Deposition | Electrical Double Layer Extraction |
|---|---|
| (EFD) | (EDLE) |
| Requires pin-like electrode to | Requires high surface area |
| locally obtain a high electric | electrode to allow extraction of a |
| field near the pin to attract | high proportion of the ions present |
| a high proportion of the ions | in the solution (low or no electric |
| out of the solution (tens to | field) |
| hundreds of V/cm) | |
| Necessity of high voltage | Effective from a few millivolts and |
| (e.g. several tens of volts) | generally below 5 volts |
| to reach sufficiently high | |
| electric fields | |
| No flow of current through the | Necessity of a capacitive current |
| solution is needed, insulated | to allow the formation of the |
| electrodes such as PE coated | electrical double layer |
| pin-like electrodes are | |
| suitable; only a high electric | |
| field is required | |
| Cations are deposited on a | Both anions and cations are |
| negative electrode and anions | extracted on the electrode, |
| on a positive one. | whatever its polarity, the anions |
| | being however slightly more |
| | extracted on a positive electrode |
| | than on a negative one due to their |
| | drift in the electric field outside |
| | the double layer region. |

In the aforementioned context, miniaturized PET radiochemical synthesis set-ups could be useful tools because these could be carried out with lower amounts of reagents: it can indeed be shown that the use of microliter scale volumes of solution fits well with the amount of reagent involved in a typical PET compound radiolabeling reaction. Thus the present application addresses a technical field very different of desalination or battery regeneration made by capacitive deionization (very low ion concentrations and migration times in a very small electrochemical cell in order to recover weak ion concentrations vs. cleaning/purification involving high ion concentrations).

Using these microscale set-ups, high radiotracer concentration allows preserving the level of specific activity and enhancing the reaction speed. Moreover, the implementation of multiple steps radio-pharmaceutical chemistry processes at the micromolar scale in miniaturised systems will provide considerable benefits in terms of product quality and purity, exposure of the operating personnel, production and operation costs as well as waste reduction. However, the standard ion exchange resins technique does not allow concentrating the radioisotope in volumes smaller than about 100 μl, which is necessary to go from initial milliliter scale [18F] fluorides solution to the desired microliter scale for the synthesis process.

### DISCLOSURE OF THE INVENTION

The present invention takes advantage of the electrical double layer extraction (EDLE) method versus the ion exchange resins extraction method while avoiding the drawbacks of the electric field deposition (EFD) technique of prior art such as side electrochemical reactions and electrode crumbling. The EDLE set-up can be integrated in the current synthesis module. By using a large specific surface area conducting material for the extraction and passing the [18F] solution directly through the latter allows to be efficient enough to be integrated in a microfluidic chip and allows concentrating the [18F] fluoride from multi-milliliters of target water down to a few microliters of solution corresponding to the void volume of the large specific surface area conducting material used as an electrode. The surface areas necessary for an efficient extraction are as high as hundreds to thousands of cm² in the method of the present invention.

In accordance to the method of the present invention, a dilute aqueous [18F] fluoride solution enters by an inlet in a cavity embodying an electrochemical cell with at least two electrodes used indifferently either as a cathode or as an anode, flows in the cavity and comes out of the cavity by an outlet, an external voltage being applied to the electrodes.

Either the cathode or the anode may behave as an extraction electrode, the other electrode polarizing the solution.

Among the electrodes, at least one electrode, thus either a cathode or an anode, is in contact and polarizes a large specific surface area conducting material contained in the cavity.

In a further step, after the ions extraction from the solution onto the extraction electrode, the extracted ions are released from the large specific surface area conducting material, by turning off the applied external voltage.

According to the method of present invention, the large specific surface area conducting material has chosen parameters and is located in the aforementioned cavity, so that to be entirely crossed and internally soaked by the dilute aqueous [18] fluoride solution flowing in the cavity.

In an optional operation mode, a flush of gas such as air, nitrogen or argon can be used, prior to the releasing step, to purge the electrochemical cell and recover most of the remaining water, whilst keeping the extracted ions inside the electrochemical cell.

In some preferred embodiments of the present invention, the electrode polarizing the fluid is close to the inlet of the cavity.

In some embodiments of the present invention, said large specific surface area is comprised between 0.1 and 1000 m²/g, and preferably between 0.1 and 1 m²/g. Of course, the greater the effective extraction surface, the greater amount of extracted ions will be obtained. Accordingly, under the term “large” specific surface area, it is meant that the total extraction surface should be of several tens of cm² at least, and not about 3 cm² as in U.S. Pat. No. 5,770,030, owing to the weak or inexistent electric field inside the “porous” conductive extraction material. It is to be recalled that, in the EDLE method, it is not the field which provokes extraction but the formation of a double ion layer (cations and anions) on the electrode surface, compensating the apparent charge of the electrode. An efficient extraction can thus be obtained even at low voltages (e.g. 1 mV), which advantageously permits to limit secondary reactions of water electrolysis or electrode crumbling reported with the EFD method.

Contrary to the method described in U.S. Pat. No. 570,030 and EP 1 260 264 A1, a (capacitive) current is established in the cell, forming the ion double layer. Contrary to the situation described in these documents, where only anions are extracted on the anode, both anions and cations can be extracted in the double layer, according to the invention, whatever the polarity of the extracting electrode (positive or negative).

In some embodiments of the present invention, the large specific surface area conducting material comprises a material selected from the group consisting of a porous conducting material, conducting fibres, conducting felts, conducting cloths or fabrics, conducting foams and conducting powders, as well as fluids flowing around or within the latter.

In some embodiments of the present invention, the fibres of the fibrous materials used have a diameter comprised between 3 and 15 microns, preferably between 7 and 12 microns. The specific surface area of the material increases with the inverse of the squared diameter of the fibres.

In some embodiments of the present invention, the large specific surface area conducting material comprises a carbon-based material, a high aspect ratio micro-structured conducting material, obtained by a microfabrication technique including laser machining, micro-machining, lithography, micromolding, reactive ion etching, etc.

In some embodiments of the invention, the large specific surface area conducting material is made of, comprises or is coated with a fraction of conducting polymers such as polyacetylene, polyaniline, polypyrrole, polythiophene or any other organic conducting material.

In some preferred embodiments of the present invention the above-mentioned carbon-based material can be found in the following list: carbon fibers, carbon cloths or fabrics, carbon felts, porous graphitic carbon, carbon aerogels/nanofoams, reticulated vitreous carbon, carbon powder, nanofibres, nanotubes and any other high surface-to-volume ratio carbon material. This list is not exhaustive and, if necessary, will be easily complemented by the person skilled in the art, in order to attain results of maximum efficiency.

In some embodiments of the present invention, the large specific surface area conducting material is used compressed to increase its surface-to-volume ratio.

According to the invention, the [18F] fluoride water solution is passed through the large specific surface area conducting material (that should not be necessarily porous or adsorbing), in order both to minimize the volume of the cell and favor intimate and very rapid contacts between the solution and the large specific surface area conducting material. Owing to the ability of the material to be “traversed” by the solution, i.e. internally soaked with the solution, it can practically occupy the whole physical space available in the cavity.

In some preferred embodiments of the present invention, the large specific surface area carbon material is polarized either positively or negatively in the range from −15V to +15V.

In some preferred embodiments of the present invention, the large specific surface area conducting material is positively polarized in the range from 0.01V to 10V, which favors a good trapping of the anions among which the [18F] fluorides in a densely packed layer, the cations being less strongly trapped in a more diffuse layer (double layer).

In some preferred mode of operation, after the [18F] fluoride solution in target water has been passed in the cell, and whilst maintaining the voltage to keep the fluoride ions in place, the large specific surface area conducting material (trapping the anions) can be rinsed by the flow of a solution through the electrochemical cell. This solution can be water, a saline solution, acetonitrile (ACN), dimethylsulfoxide (DMSO), dimethylformamide (DMF), tetrahydrofuran (THF), an alcohol such as tert-butanol, a mix of solvents, or any solution usable to purposely eliminate undesired chemical species present in the cell but created in the water after its irradiation.

In some preferred embodiments, the electrochemical cell is further rinsed with an organic solvent to purposely eliminate water from the electrochemical cell.

In some embodiments of the invention this drying step is assisted by heating up the cell in the range comprised between 50 and 150° C., either externally or internally, using a built-in heating system.

In some preferred embodiments of the present invention, the heating is performed internally by the resistive heating of a metallic electrode in the vicinity of or in contact with the cell or the large specific surface area conducting material itself.

In some preferred embodiments, after the extraction process, the ions are released by switching off the external voltage or even by switching off the external voltage and short-circuiting of the electrodes. Contrary to the EFD method, a potential inversion would be less efficient for releasing the captured ions, because it only leads to an ion inversion in the double layer, whilst the ions remain fixed on the electrode. An electrode short-circuit is therefore preferable so that to discharge the capacitor formed during the extraction step.

Releasing the electric field results in a reconcentrated solution of [18F] fluorides, now freed at the surface or in the “porous” bulk of the extraction electrode, and that thus remain in the void volume within or around the large specific surface area conducting material. The volume of a solution in which the ions can be released and recovered is practically proportional to the void volume inside the cavity of the electrochemical cell.

In some operation modes of the present invention, before switching off the voltage, the polarity is reversed to reverse the electrical double layer of ions and make the anions, among which the [18F] fluorides, come in the outer and more diffuse layer to facilitate the release of the ions in the surrounding solution.

In some embodiments of the present invention the ions are released by alternating negative and positive polarization of the large specific surface area conducting material.

In some embodiments of the invention, the ions, among which the [18F] fluorides, are rinsed out of the electrochemical cell by a saline aqueous solution. The solution obtained is then readily usable, e.g. injectable after dilution, for medical imaging.

In some other embodiments of the invention, after the extraction process, the electrochemical cell is rinsed with an organic solvent that allows rinsing out the water from the large specific surface area conducting material and the electrochemical cell. This allows therefore the elimination of the residual water that may be undesirable for a subsequent chemical processing such as a nucleophilic substitution.

In some embodiments of the invention an air or gas flush passes through the cell during the heating process to drag up out the vapor of mixture of water and a suitable organic solvent (acetonitrile, DMSO, alcohols, THF, etc.) azeotropically mixed thereto.

In some embodiments of the present invention, the dried electrochemical cell can be used as a means of conveyance for dry [18F] isotopes from a production center (cyclotron) to a place where it will be used for PET radiotracers preparation such as a radiopharmacy, a research laboratory or a hospital pharmacy.

In some embodiments of the present invention, the water-free electrochemical cell containing the extracted ions, after extraction and convenient rinsing, can be used as a reactor or a part of a reaction circuit to directly carry out a subsequent chemical labeling reaction with the radiotracer, i.e. a nucleophilic substitution.

In some embodiments of the present invention, the ions, among which the [18F] fluorides, are released by first filling the electrochemical cell with a dry organic solution containing a salt.

In some embodiments of the invention, the solubility of the salt in the organic media is ensured by a phase transfer agent such as Kryptofix 222® or quaternary ammonium salts.

In some embodiments of the invention, the so-obtained water-free organic solution containing the [18F] fluorides is used for the synthesis of a PET radiotracer.

Another object of the present invention relates to an electrochemical cell for extracting out of water, concentrate and reformulate an electrically charged radionuclide by the capacitive deionization method, embodied by a cavity comprising:
an inlet;
an outlet;
at least two electrodes to which an external voltage can be applied, one electrode intended to be used as an extraction electrode, another one intended to be used for polarizing the solution, according to said method;
a large specific surface area conducting material, contained in the cavity, in contact with and polarized by at least the extraction electrode, either used as a cathode or as an anode;
   wherein the volume of the cavity is comprised between 1 and 5000 microliters, preferably between 1 and 500 microliters, and the specific surface area of the large specific surface area conducting material is comprised between 0.1 and 1 m²/g.

### BRIEF DESCRIPTION OF THE DRAWINGS

FIG. 1 shows schematically an electrochemical set-up for [18F] fluorides electrical double layer extraction: A) Electrochemical cell side view; B) Electrochemical cell top view. According to FIG. 1, the electrochemical set-up comprises an inlet 1, an outlet 2, a first electrode 3 polarizing the fluid, a second electrode 4 polarizing the large specific surface area conducting material 7, a third electrode 5 used to heat up the large specific surface area conducting material by a resistive current, a cavity 6 (e.g. 5 mm×45 mm×1 mm) and the large specific surface area conducting material 7 disposed in cavity 6. ΔV1 is the voltage applied to polarize the large specific surface area conducting material 7 and ΔV2 is the voltage applied to heat up the large specific surface area conducting material 7 by resistive heating.

FIG. 2 shows the evolution of the extraction efficiency vs. the voltage applied to polarize carbon felts, used as a large specific surface area conducting material in the electrochemical device of FIG. 1.

### EXAMPLES

### Example 1

### EDLE of [18F] Fluorides on Carbon Fibers

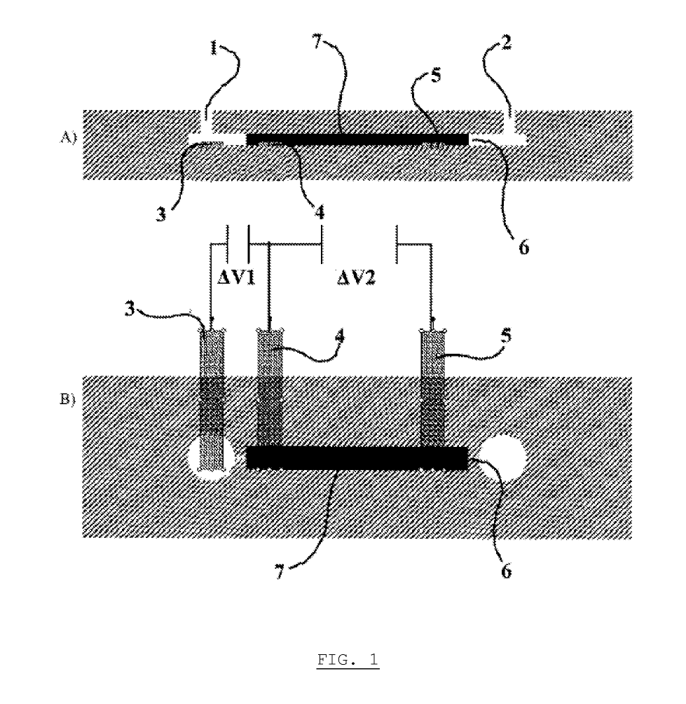

In the electrochemical set-up as shown on FIG. 1, the large specific surface area conducting material 7 consists in bundles of carbon fibers. The specific surface area in this case is 4375 cm²/g. A voltage of +3V is applied to the electrode 4, that polarizes the bundles of carbon fibers. A 2 ml solution containing 1.47 mCi of [18F], obtained by rinsing a cyclotron target with water and diluting it, is passed through the electrochemical cell in 1 minute using a syringe pump. The activity extracted from the solution and actually trapped in the electrochemical cell is measured. This allows extracting 98+% (1.44 mCi) of the activity entering in the cell.

### Example 2

### EDLE of [18F] Fluorides on a Reticulated Vitreous Carbon (Duocel® from ERG, Oakland, Canada)

In the electrochemical set-up as shown on FIG. 1, the large specific surface area conducting material 7 consists in this case in carbon aerogel/nanofoam. A voltage of +6V is applied to the electrode 4, that polarizes the reticulated vitreous carbon. A 2 ml solution containing 1.4 mCi of [18F], obtained as for example 1, is passed through the electrochemical cell in 1 minute using a syringe pump. The activity extracted from the solution and actually trapped in the electrochemical cell is measured. This allows extracting 31+% (405 μCi) of the activity entering in the cell.

### Example 3

### EDLE of [18F] Fluorides on a Carbon Aerogel/Nanofoam Monolith (from Marketech International Inc., Port Townsend, Wash., USA)

In the electrochemical set-up as shown on FIG. 1, the large specific surface area conducting material 7 consists in this case in carbon aerogel/nanofoam. A voltage of +3V is applied to the electrode 4, that polarizes the carbon aerogel/nanofoam. A 2 ml solution containing 1 mCi of [18F], obtained as for example 1, is passed through the electrochemical cell in 1 minute using a syringe pump. The activity extracted from the solution and actually trapped in the electrochemical cell is measured. This allows extracting 19+% (194 μCi) of the activity entering in the cell. Actually, there were preferential pathways in the vicinity of the carbon aerogel. Moreover, the liquid can not enter the nanopores because the transit time is too short; if the flowrate is four times reduced, the extracted amount of activity is 36%.

### Example 4

### EDLE of [18F] Fluorides on Porous Graphitic Carbon (PGC) Powder (Liquid Chromatography Stationary Phase from Thermoelectron Corp., Burlington, Canada)

The electrochemical set-up is the same as shown on FIG. 1, except that one filter (sintered) is used to retain the porous graphitic carbon powder in the cell cavity 6. The large specific surface area conducting material 7 is thus in this case porous graphitic carbon powder. A voltage of +6V is applied to the electrode 4, that polarizes the porous graphitic carbon powder. A 2 ml solution containing 780 μCi of [18F] is passed through the electrochemical cell in 10 minutes; due to the high pressure drop caused by the powder, the syringe pump does not allow to reach a flow rate higher than 200 μl/min. The activity extracted from the solution and actually trapped in the electrochemical cell is measured. This allows extracting 63+% (435 μCi) of the activity entering in the cell.

### Example 5

### EDLE of [18F] Fluorides on a Carbon Felt (from SGL Carbon AG, Wiesbaden, Germany)

The electrochemical set-up as shown on FIG. 1, the large specific surface area conducting material 7 consists in this case in carbon felt. A voltage of +6V is applied to the electrode 4 and is used to polarize the carbon felt. A 2 ml solution containing 1 mCi of [18F], obtained by rinsing the cyclotron target with water and diluting it, is passed through the electrochemical cell in 1 minute using a syringe pump. The activity extracted from the solution and actually trapped in the electrochemical cell is measured. This allows extracting 99+% (992 μCi) of the activity entering in the cell.

### Example 6

### Influence of the Voltage on the EDLE of [18F] Fluorides on a Carbon Felt (from SGL Carbon, Wiesbaden, Germany)

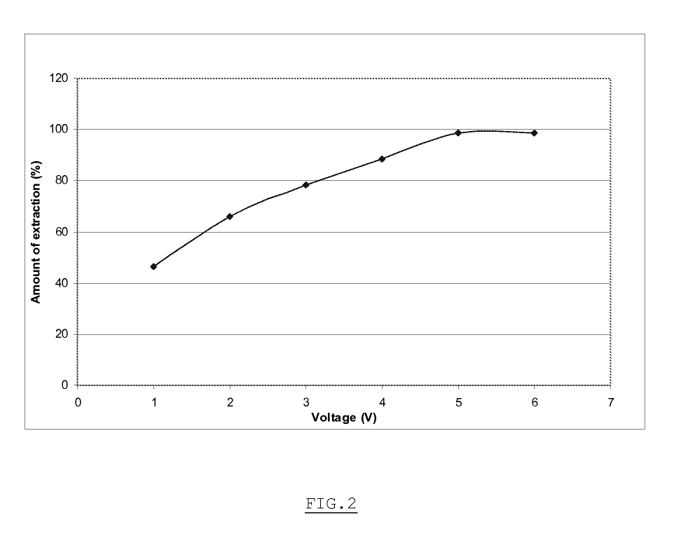

The electrochemical set-up is shown on FIG. 1; the large specific surface area conducting material 7 is in this case carbon felt. 2 ml solutions containing 1 mCi of [18F], obtained by rinsing the cyclotron target with water and diluting it, are passed through the electrochemical cell in 1 minute using a syringe pump. Voltages from +1V to +6V by 1V steps are applied to the electrode 4, that polarizes the carbon felt. The activity extracted from the solution and actually trapped in the electrochemical cell is measured. The increase of voltage results in an increase of the activity actually extracted from the solution that was passed through the electrochemical cell, ranging from 46% up to 98.6% at +5V and 98.8% at +6V. The results are shown on FIG. 2.

### Example 7

### Effect of the Rinsing of the Cell with Various Solutions on the Release of the Activity Trapped on Carbon Fibers and Carbon Felts

The experimental electrochemical set-up is the same then in example 1. 1 ml of a selected solution is passed through the cell in 30 s using a syringe pump, and the amount of activity rinsed out from the electrochemical set-up is measured and compared to the amount remaining in the set-up. The results are summarized in Table 1:

TABLE 1

| Experimental | Carbon fibers | | | Carbon felts | | | |
|---|---|---|---|---|---|---|---|
| data | | | 1 mmol | | | 1 mmol | |
| Solution (1 ml) | Water | Dry ACN | aq. K₂CO₃ | Water | Dry ACN | aq. K₂CO₃ | NaCl 0.9% |
| Voltage | 0 V | 0 V | +3 V | 0 V | 0 V | +3 V | +3 V |
| Results (amount | <3% | <1% | <3% | <2% | <1% | <3% | <2% |
| released) | | | | | | | |

### Example 8

### Release of the Activity from the Large Specific Surface Area Conducting Material

The experimental electrochemical set-up is the same then in example 1. 1 ml of a selected solution [type 1: water 1 mmol K₂CO₃ solution; type 2: dry ACN (acetonitrile) 1 mmol K₂CO₃/K222 solution] is passed through the cell in 30 s, and the amount of activity rinsed out is measured and compared to the amount remaining in the set-up after A) switching off the voltage (0V) and B) short-circuiting the electrochemical cell (connection between electrodes 3 and 4). The results are summarized in Table 2.

TABLE 2

| | | | | | Porous | | | | Reticulated | |
|---|---|---|---|---|---|---|---|---|---|---|
| | Carbon fibers | | Carbon felt | | graphitic carbon | | Carbon aerogel | | vitreous carbon | |
| Solution | Type 1 | Type 2 | Type 1 | Type 2 | Type 1 | Type 2 | Type 1 | Type 2 | Type 1 | Type 2 |
| Amount | 85% | — | 91% | — | 34% | — | 31% | — | 84% | — |
| released A) | | | | | | | | | | |
| Amount | 93% | 92% | 98% | 97% | 40% | — | 32% | — | 98% | 97% |
| released B) | | | | | | | | | | |

1.-22. (canceled)

23. A method to extract out of water, concentrate and reformulate [18F] fluorides, said method comprising the steps of:
passing a dilute aqueous [18F] fluoride solution, so that the dilute aqueous [18F] fluoride solution successively enters by an inlet in a cavity embodying an electrochemical cell comprising at least three electrodes each subjected to an external voltage:
a first electrode used for polarizing the solution;
a second electrode used as an extraction electrode; indifferently as a cathode or as an anode, in contact with and polarizing positively, negatively respectively, in the range from −15V to +15V, a large specific surface area conducting material contained in the cavity; and
a third electrode optionally used for heating up said large specific surface area conducting material by a resistive current, said large specific surface area conducting material being located for a major part between ends in the cavity of the second and the third electrode;
flows in the cavity directly through said large specific surface area conducting material by entirely crossing and internally soaking the large specific surface area conducting material, so that [18F] fluoride anions are extracted on said large specific surface area conducting material by an electrical double layer extraction or EDLE method,
comes out of the cavity by an outlet, and;
releasing the extracted anions from the surface of the large specific surface area conducting material by turning off the applied external voltage.

24. Method according to claim 23, wherein, before the step of releasing the extracted ions, a flush of gas is injected into the cavity to purge the electrochemical cell and recover most of the remaining water therein, while keeping the extracted ions inside the electrochemical cell on the extraction electrode.

25. Method according to claim 23, wherein the large specific surface area conducting material comprises a material selected from the group consisting of: a porous conducting material, conducting fibers, conducting felts, conducting cloths or fabrics, conducting foams and conducting powders, as well as fluids flowing around or within the conducting foams and conducting powders.

26. Method according to claim 25, wherein the large specific surface area conducting material comprises a material selected from the group consisting of: a carbon-based material, a high aspect ratio micro-structured material obtained by a microfabrication process, a conducting polymer, another organic conducting material and any combination of the materials of the group.

27. Method according to claim 25, wherein the fibers of the fibrous materials have a diameter comprised between 3 and 15 microns, preferably between 7 and 12 microns.

28. Method according to claim 26, wherein the large specific surface area conducting material is selected from the group consisting of: carbon fibers, carbon cloths or fabrics, carbon felts, porous graphitic carbon, carbon aerogels/nanofoams, reticulated vitreous carbon, carbon powder, nanofibres and nanotubes.

29. Method according to claim 26, wherein the conducting polymer is selected from the group consisting of: polyacetylene, polyaniline, polypyrrole and polythiophene.

30. Method according to claim 23, wherein the large specific surface area conducting material is used compressed to increase its surface-to-volume ratio.

31. Method according to claim 23, wherein the large specific surface area electrode is positively polarized, in the range from 0.01V to 10V.

32. Method according to claim 25, wherein, while submitted to a voltage, the large specific surface area conducting material is rinsed by a flow of a fluid selected from the group consisting of: water, a saline solution, ACN, DMSO, DMF, THF, an alcohol, a mix of solvents and any solution purposely usable to eliminate any chemical species present in the cell and created in the water after its irradiation.

33. Method according to claim 32, wherein the large specific surface area conducting material is further rinsed with an organic solvent to purposely eliminate water from the electrochemical cell.

34. Method according to claim 33, wherein the elimination of water is enhanced by heating up the cell in the range between 50° C. and 150° C.

35. Method according to claim 34, wherein an air flush further passes through the cell during the heating process to sweep out the vapor of water and an organic solvent azeotropically mixed thereto.

36. Method according to claim 23, wherein the ions are further released from the surface of the large specific surface area conducting material by an operation selected from the group consisting of:
switching off the external voltage,
creating a short-circuit between the polarizing electrode and the extracting electrode,
a combination of the operations mentioned above.

37. Method according to claim 33, wherein the water-free electrochemical cell is used as reactor or within a reaction circuit for the chemical synthesis of a radiotracer.

38. Method according to claim 33, wherein the ions, among which the [18F] fluorides, are released after filling the electrochemical cell with a dry organic solution containing a salt, the solubility of the salt in the organic medium being ensured by a phase transfer agent such as Kryptofix 222 or quaternary ammonium salts.

39. Method according to claim 38, wherien the so water-free organic solution containing the [18F] fluorides is further used for the synthesis of a PET radiotracer.

40. Electrochemical cell for extracting out of water, concentrate and reformulate an electrically charged radionuclide by the capacitive deionization method, embodied by a cavity comprising:
an inlet;
an outlet;
at least three electrodes to which an external voltage can be applied;
a first electrode intended to be used for polarizing the solution;
a second electrode intended to be used in operation as an extraction electrode according to the EDLE method, indifferently as a cathode or as an anode, and to be in contact with and polarizing positively, negatively respectively, in the range from −15V to +15V, a large specific surface area conducting material contained in the cavity; and
a third electrode intended to optionally be used for heating up said large specific surface area conducting material by means of a resistive current
said large specific surface area conducting material, located and configured for a major part between ends in the cavity of the second and the third electrode, so that to be entirely crossed and internally soaked by a solution containing an electrically charged radionuclide passed through the cavity between the inlet and the outlet,
wherein the volume of the cavity comprises between 1 and 5000 microliters, and the specific surface area of the large specific surface area conducting material comprises between 0.1 and 1 m²/g.

41. Electrochemical cell according to claim 40, wherein the third electrode is in the vicinity of or in contact with the cell or the large specific surface area conducting material.

42. Electrochemical cell according to claim 40, wherein the volume of the cavity comprises between 1 and 500 microliters.
